(19) United States
(12) Patent Application Publication
(10) Pub. No.: US 2012/0102755 A1
(43) Pub. Date: May 3, 2012

(54) Electrical Two-Way Rotary Trimmer

(75) Inventors: Mikael Racov, Huskvarna (SE); Johan Svennung, Jonkoping (SE); Mia Herou, Bankeryd (SE)

(73) Assignee: HUSQVARNA AB, Huskvarna (SE)

(21) Appl. No.: 13/379,707

(22) PCT Filed: Jul. 9, 2009
(86) PCT No.: PCT/SE09/50887

§ 371 Date: Dec. 21, 2011

(51) Int. Cl. A01D 34/416; A01D 34/82

(52) U.S. Cl. 30/142; 30/276

(57) ABSTRACT

An electrical trimmer (20) for rotary cutting in a garden comprising a rotary cutting equipment (1) for cutting grass or other vegetation, and an electrical motor (2) for driving the rotary cutting equipment (1). The electrical trimmer (20) further comprises a switching means (4) for changing the rotation direction of the electrical motor drive between clockwise (A) and counterclockwise (B) rotation for the rotation of the rotary cutting equipment (1).

### FIELD OF THE INVENTION

This invention relates to a electrical trimmer for cutting grass or other vegetation. The electrical trimmer comprises a rotary cutting equipment and an electrical motor for driving the rotary cutting equipment,

### BACKGROUND

When trimming in a garden, the grass cut by the trimmer is thrown in a certain direction. To control that direction one has to walk in a certain direction along the cutting path for the grass to end up on, for instance, the lawn instead of the pavement.

Hence, there is a need for a handheld electrical trimmer that can control the direction in which the cut grass is thrown when trimming in a garden without the operator having to walk in a certain direction or hold the trimmer in a certain angle.

### SUMMARY OF THE INVENTION

It order to solve the above problem a handheld electrical trimmer is provided according to the preamble of claim 1 and which is characterized in that the electrical trimmer comprises a switching means for changing the rotation direction of the electrical motor drive between clockwise and counterclockwise rotation for rotation of the rotary cutting equipment. Hence, the rotation direction of the cutting equipment is controllable and the direction in which the cut grass is thrown can thereby be controlled.

Embodiments of the invention are presented in the dependent claims, as well as in the following description and drawings.

According to the present invention, an electrical trimmer for rotary cutting is provided, comprising a rotary cutting equipment for cutting grass or other vegetation, and an electrical motor for driving the rotary cutting equipment, characterized in that the electrical trimmer comprises a switching means for changing the rotation direction of the electrical motor drive between clockwise and counterclockwise rotation for the rotation of the rotary cutting equipment.

This gives an electrical trimmer that with a simple change of a switching means changes the rotation direction and the grass that is cut may be thrown in the opposite direction.

In one embodiment, the rotation direction of the electrical motor may be changed, by using the switching means, during operation of the trimmer. This means the motor does not have to be stopped before the rotation direction can be changed.

In one embodiment, the electrical trimmer may be battery-powered. This gives the opportunity of the handheld trimmer to be wireless.

In one embodiment may the rotary cutting equipment comprise cutting line for cutting the grass or other vegetation. An alternative may be knife blades in the cutting equipment. The knife blades would then need to be double-sided, and the cutting line may therefore be an easier and cheaper alternative.

The rotary cutting equipment may in one embodiment be attached to the trimmer by snapping means. Since the rotary cutting equipment is rotating both clockwise and counterclockwise, a threaded connection between the cutting equipment and the trimmer is not possible. The cutting equipment would come loose. When attached by a snapping function, the cutting equipment may rotate in any direction and still be attached.

In one embodiment, the electrical trimmer may further comprise a trim shield. The trim shield may be attached to the trimmer close to the rotary cutting equipment for protective function during trimming.

The trim shield may in one embodiment be symmetrically arranged on the trimmer for protective function. By symmetrically arranged means that the trim shield has the same protective function during both clockwise and counterclockwise rotation direction of the cutting equipment.

In another embodiment, the trim shield may comprise at least two knives. The knives may be arranged on the side of the trim shield facing the cutting equipment. When using line for the cutting function in the cutting equipment, the line may during use be worn and get shorter. The cutting equipment may be designed to feed out line when the cutting equipment is tapped to the ground. When doing this, the line might get too long so that it damages the trim shield during rotation of the cutting equipment. The purpose of the knives on the trim shield are to shorten the line so that it gets the correct length. When the line rotates against the trim shield, the knives cut off the outermost part of the line.

In a further embodiment the at least two knives may be arranged opposite to each other on the trim shield. In this way the grass cutting line in the cutting equipment may be kept short enough when rotating both clockwise and counterclockwise.

### BRIEF DESCRIPTION OF THE DRAWINGS

In the following, an embodiment will be described in more detail with reference to the accompanying drawings.

FIG. 1 is a perspective view of the bottom part of the electrical trimmer.

FIG. 2 is a top view of the rotary cutting equipment, the motor and the trim shield attached to the electrical trimmer.

FIG. 3 is a perspective view of an embodiment of the electrical trimmer.

FIG. 4 is a perspective view of a control part of the electrical trimmer.

### DETAILED DESCRIPTION

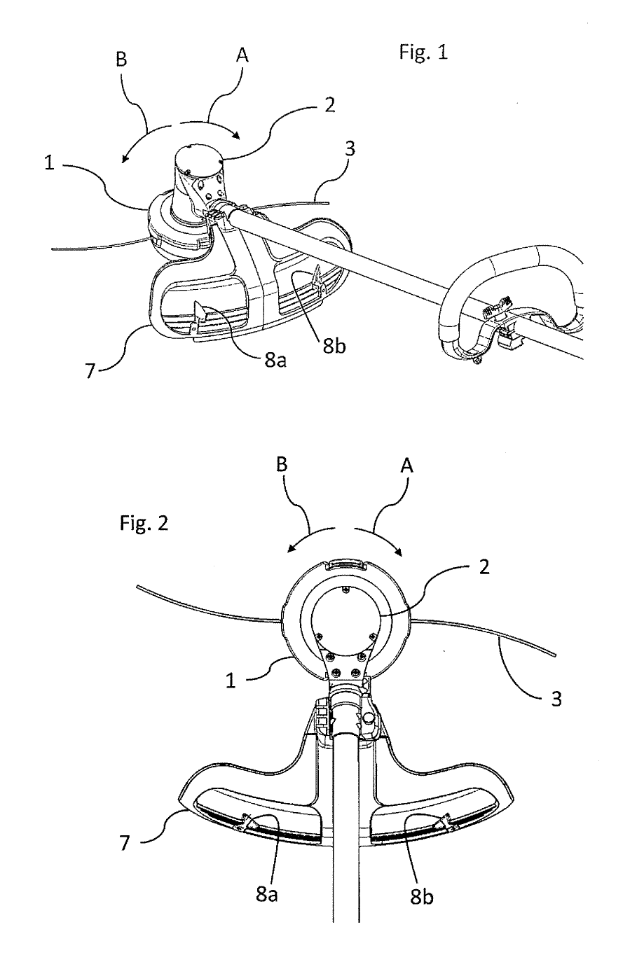

In FIGS. 1 to 4 an electrical trimmer 20 is shown. With reference to FIGS. 1 and 2, a bottom part of the electrical trimmer comprises a rotary cutting equipment 1, a motor 2 and a trim shield 7. The rotary cutting equipment 1 comprises a cutting line 3 that cuts the grass or other vegetation.

The rotary cutting equipment 1 may, in another embodiment, comprise a knife blade instead of a cutting line. The knife would then need to be sharpened on both sides of the blade.

When using line 3 in the cutting equipment 1, the cutting equipment 1 may, in a known manner, comprise line 3 winded on a spool inside the cutting equipment 1. When the cutting equipment 1 is tapped to the ground, more line 3 may be fed out.

The rotary cutting equipment 1 may be attached to the trimmer 20 by a snapping function. Since the cutting equipment 1 may rotate both clockwise A and counterclockwise B, it can not be attached to the trimmer by a threaded connection. It would come loose when rotating in the same direction as the threads are turning. Other attachment solutions providing the same functonality during clockwise and counterclockwise rotations may also be possible.

The cutting equipment 1 is connected to the motor 2, which drives the cutting equipment 1 and controls the speed and direction of the cutting.

A trim shield 7 may be arranged on the trimmer behind the rotary cutting equipment 1. The trim shield 7 may be a protection for the cut grass that is thrown away from the cutting equipment 1. The trim shield 7 may be designed to direct the cut grass in a certain way. Since the line 3 may rotate both clockwise A and counterclockwise B, the trim shield 7 may be symetrically arranged to give the same protective function for both rotation directions. The trim shield 7 may also have a protective function for the user against the rotating line 3. The line 3 could otherwise cause injury to the user if his or her feet get hit by the line 3.

When tapping the trimmer to the ground to feed out more line, the line 3 may get too long so that it will hit the trim shield 7 when rotating. To prevent damage to the trim shield 7, it may be provided with knives 8a, 8b that cut off the outermost part of the line 3. To cut off the line 3 both when it rotates clockwise A and when it rotates counterclockwise B, there may be at least two knives, and these two knives may be arranged in opposite direction to each other. One knife 8a may cut the line when the line 3 rotates clockwise A and the other knife 8b may cut the line when the line 3 rotates counterclockwise B.

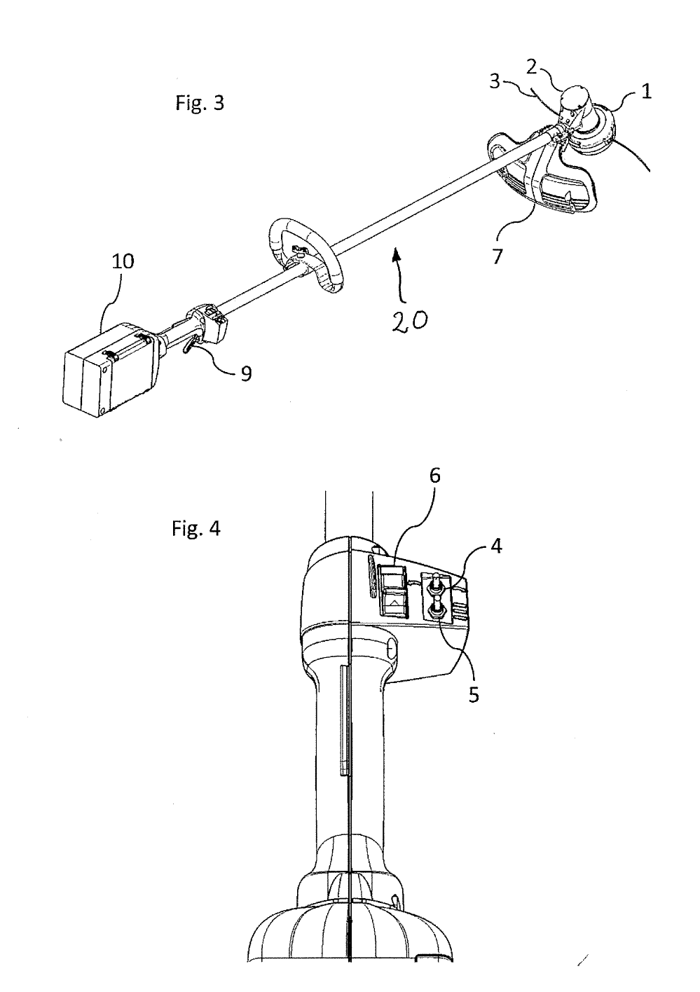

Referring to FIGS. 3 and 4, the electrical motor 2 may be battery-powered by a battery pack 10 arranged on a upper part of the electrical trimmer. On the upper part of the electrical trimmer may a control part be arranged. The control part comprises means for powering the motor 2 and controlling the rotation direction of the motor 2. There may be a main switch 6 to turn on the powering of the motor 2. The means for changing rotation direction of the motor may comprise a switch 4 that may be switched to the right or to the left for clockwise A or counterclockwise B rotation of the motor 2. There may further be a speed control switch 5 for different speed levels of the motor 2 and a speed control handle 9 for controlling the speed of the motor 2 rotation during operation.

Since the trimmer is provided with an electrical motor 2, the rotation direction change may be done with a simple switch 4, changing the polarity of the power from the battery pack 10 that drives the motor. This includes that the change of direction may be done instantly during operation of the trimmer 20, without a need for turning the trimmer 20 off.

1. Electrical trimmer for rotary cutting comprising,
a rotary cutting equipment, for cutting grass or other vegetation, and
an electrical motor for driving the rotary cutting equipment,
wherein the electrical trimmer comprises a switching means for changing the rotation direction of the electrical motor drive between clockwise and counterclockwise rotation for rotation of the rotary cutting equipment.

2. Electrical trimmer according to claim 1, wherein the rotation direction of the electrical motor drive can be changed during operation of the trimmer.

3. Electrical trimmer according to claim 1, wherein the electrical trimmer is battery-powered.

4. Electrical trimmer according to claim 1, wherein the rotary cutting equipment comprises a cutting line for cutting grass or other vegetation.

5. Electrical trimmer according to claim 1, wherein the rotary cutting equipment is attached to the electrical trimmer by snapping means.

6. Electrical trimmer according to claim 1, wherein the electrical trimmer further comprises a trim shield.

7. Electrical trimmer according to claim 6, wherein the trim shield is symmetrically arranged for protective function during both clockwise and counterclockwise rotation of the rotary cutting equipment.

8. Electrical trimmer according to claim 7, wherein the trim shield comprises at least two knives.

9. Electrical trimmer according to claim 8, wherein the at least two knives are arranged opposite to each other on the trim shield.
